(19) United States
(12) Patent Application Publication
(10) Pub. No.: US 2023/0074822 A1
(43) Pub. Date: Mar. 9, 2023

(54) COMBINED FITNESS AND TELEVISION MIRROR

(71) Applicant: ClearView Innovations LLC, Bensenville, IL (US)

(72) Inventor: Brian J. Walter, Arlington Heights, IL (US)

(21) Appl. No.: 17/901,155

(22) Filed: Sep. 1, 2022

Related U.S. Application Data
(60) Provisional application No. 63/242,120, filed on Sep. 9, 2021.

(51) Int. Cl. H04N 9/30; G02B 7/182; H04N 7/015

(52) U.S. Cl. CPC H04N 9/30; G02B 7/182; H04N 7/015

(57) ABSTRACT

A combined fitness and television mirror comprises a generally rectangular housing having a front opening. A semi-transparent mirror is mounted in the housing front opening. A display monitor is mounted in the housing rearwardly of the mirror and is visible through the mirror when the display monitor is in an on state. A video control system in the housing generates video signals to drive the monitor. The video control system comprises a programmed processor and memory, a plurality of input ports, a television controller, an app controller and an orientation sensor for sensing orientation of the housing in one of a portrait mode or a landscape made. The video control system is configured to generate the video signals from the television controller if the sensor senses the landscape orientation and to generate the video signals from the app controller if the sensor senses the portrait orientation.

### CROSS-REFERENCE TO RELATED APPLICATIONS

This application claims priority of Provisional Ser. No. 63/242,120, filed Sep. 9, 2021, the disclosure of which is hereby incorporated by reference in its entirety.

### FIELD OF THE INVENTION

The invention relates to television mirrors and fitness mirrors and, more particularly, to a system which combines features of both in one device.

### BACKGROUND

In the early 2000's, the desire to incorporate television, or TV, technology into mirror design was growing, as was the technology to make such a product. Visionaries and fabricators worked to furnish a product capable of accenting a bathroom, living room, den, corporate lobby or conference room, hotel message board, airport lounge, bar, hair salon, outdoor patio, swimming pool, or a boat. However, with existing technology the TVs were too thick to be mounted like a mirror, and designs lacked euphonic integration. Each order had to be custom made at high cost to the supplier and the customer.

In the ensuing years, Applicant herein found better components and standards to perfect designs. New TV products were developed that were powerful for the home and commercial electronics integrator while flexible enough to appeal to the architect and designer.

Today the results of these designs are found in TV mirror products. These products can be found in a number of private home designs as well as in corporate and retail installations.

A conventional TV mirror allows customers to combine style and entertainment in one. The sleek look of a finely crafted mirror with the vivid colors of a high-performance television. The typical TV mirror uses a semi-transparent mirror with a TV behind the mirror. When the TV is on the image from the TV is visible through the mirror. When the TV is off the mirror reflects images in a conventional manner. The TV may be visible through the entire mirror or through a small portion of the mirror, as desired.

Additionally, fitness mirrors have recently found widespread acceptance. Fitness mirrors supplement exercise equipment and are designed to make it easier than ever to workout at home. Fitness mirrors have a reflective display that allows a user to stream an exercise class from a smart device app while keeping an eye on the user's posture and form. Similar to TV mirrors, when the fitness mirror is turned off, they look like regular mirrors and can blend in with one's home decor.

TV mirrors and fitness mirrors differ in that the former requires television signal processing devices, such as television tuners and the like. A fitness mirror includes no such functionality and only includes an app that controls the software in the mirror. Also, most television programs are displayed in landscape mode. Fitness mirrors are typically installed in a portrait mode as such apps are most typically used on a smart phone or tablet in a portrait mode.

The invention described herein combines features of both a TV mirror and a fitness mirror in a single device.

### SUMMARY

The invention relates to a combined television mirror and fitness mirror in one which can be used in portrait mode or landscape mode as desired.

In accordance with one aspect, a combined fitness and television mirror comprises a generally rectangular housing having a front opening. A semi-transparent mirror is mounted in the housing front opening. A display monitor is mounted in the housing rearwardly of the mirror and is visible through the mirror when the display monitor is in an on state. A video control system in the housing generates video signals to drive the monitor. The video control system comprises a programmed processor and memory, a plurality of input ports, a television controller, an app controller and an orientation sensor for sensing orientation of the housing in one of a portrait mode or a landscape made. The video control system is configured to selectively generate the video signals from one of the television controller or the app controller and to adjust orientation of the video signals responsive to orientation of the housing.

The combined fitness and television mirror housing may comprise a frame defining the front opening and a back cover.

It is a feature that the orientation sensor comprises a gyro sensor.

It is another feature that the control system comprises a Wi-Fi antenna for receiving input signals for the television controller and/or the app controller.

The control system may comprise an HDMI input for receiving input signals for the television controller, and/or a USB input for receiving input signals for the app controller.

It is a further feature that the display monitor has a screen size substantially equal to size of the front opening.

It is yet another feature that the television controller comprises a digital tuner.

There is disclosed in accordance with another aspect a combined fitness and television mirror comprising a generally rectangular housing having a front opening. A semi-transparent mirror is mounted in the housing front opening. A display monitor is mounted in the housing rearwardly of the mirror and visible through the mirror when the display monitor is in an on state. A video control system in the housing generates video signals to drive the monitor. The video control system comprises a programmed processor and memory, a plurality of input ports, a television controller to display television programs, an app controller to stream an exercise class, and an orientation sensor for sensing orientation of the housing in one of a portrait mode or a landscape made. The video control system is configured to generate the video signals from the television controller if the sensor senses the landscape orientation and to generate the video signals from the app controller if the sensor senses the portrait orientation.

It is yet another feature that a keypad is operatively connected to the video control system and is adapted to provide input commands to control selection of the video signals or to override the orientation sensor to select the video signals.

It is still another feature that an infrared receiver is operatively connected to the video control system and is adapted to receive input commands from a remote control to control selection of the video signals or to override the orientation sensor to select the video signals.

Further features and advantages will be readily apparent from the specification and the drawings.

### BRIEF DESCRIPTION OF THE DRAWINGS

FIG. 1 is a front perspective view of a combined television and fitness mirror system in accordance with the invention in landscape orientation and operating in a television mode;

FIG. 2 is a front perspective view of the combined television and fitness mirror system of FIG. 1 in portrait orientation and operating in a fitness mode;

FIG. 3 is a front perspective view of the combined television and fitness mirror system of FIG. 1;

FIG. 4 is a front perspective exploded view of the combined television and fitness mirror system;

FIG. 5 is a rear perspective exploded view of the combined television and fitness mirror system;

FIG. 6 is a block diagram of circuitry for the system of FIG. 1;

FIG. 7 is a flow diagram for operation of the control system of FIG. 6; and

FIG. 8 is an elevation view illustrating manipulation of the system between the portrait orientation and the landscape orientation.

### DETAILED DESCRIPTION OF THE INVENTION

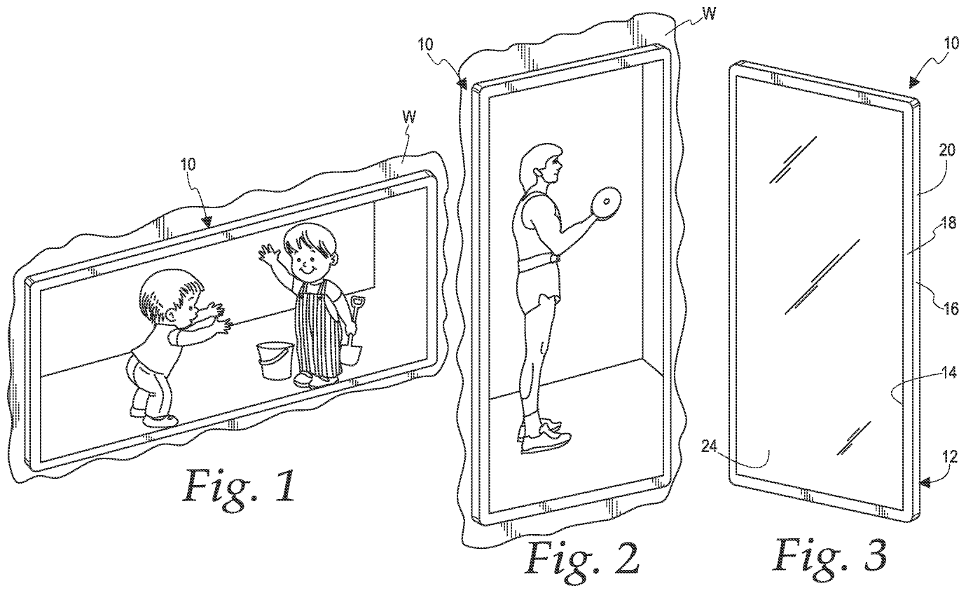

Disclosed herein is a combined television and fitness mirror system 10, see FIG. 1-3, in accordance with the invention The system 10 normally functions as a conventional mirror as shown in FIG. 3. FIG. 1 illustrates the system 10 mounted to a wall W and in a landscape orientation suitable for TV viewing. A TV program is displayed in the illustration. FIG. 2 illustrates the system 10 mounted to the wall W and in a portrait orientation suitable for fitness applications. A fitness application image is displayed. Thus, the system 10 provides a TV when you want, a mirror when you don't and fitness when you need. It is an all-in-one solution featuring a high-end 4k television monitor built into a finely crafted mirror, along with circuitry and software to implement fitness or other apps. In accordance with one aspect of the invention, the system 10 is configured to automatically switch between TV mode when in the landscape orientation and fitness mode when in the portrait orientation. As will be apparent, the system 10 can selectively be used in either TV or fitness mode in either orientation.

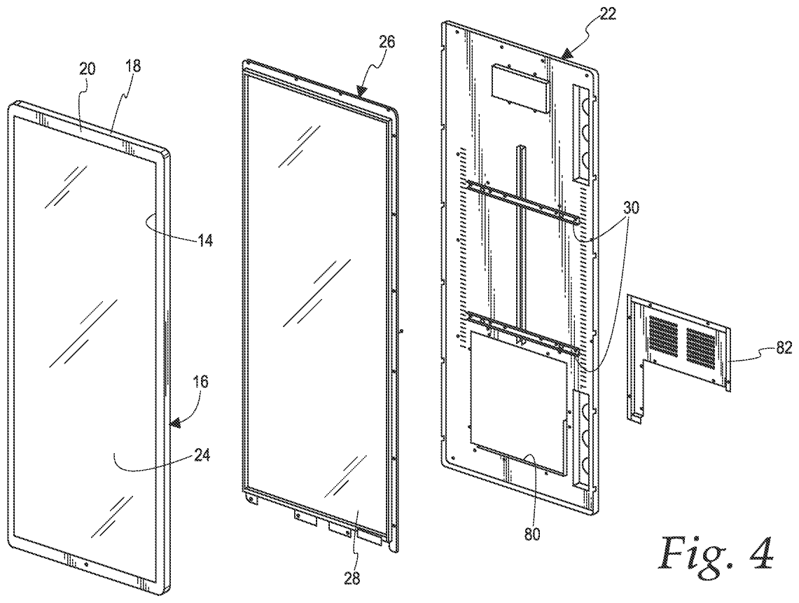

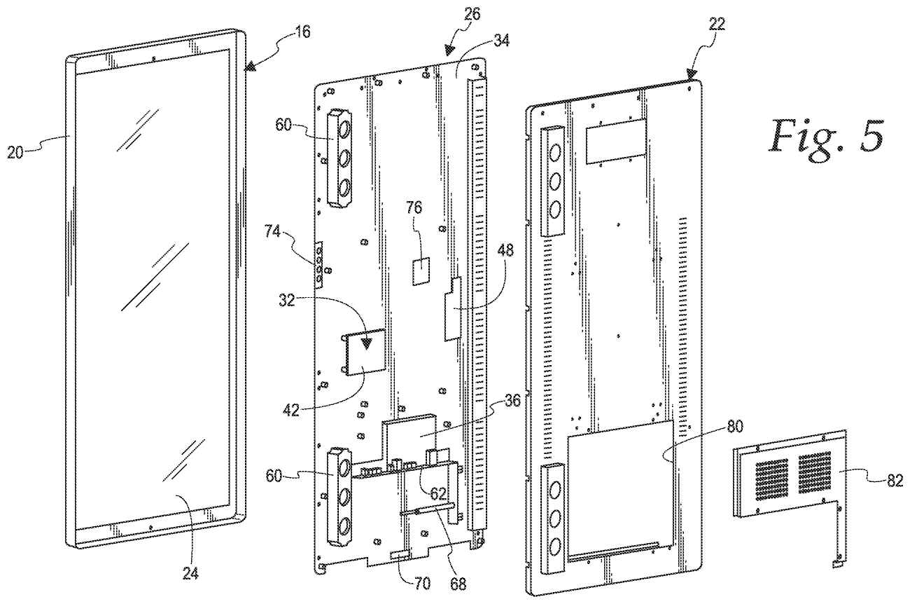

Referring to FIGS. 3-5, the system 10 includes a generally rectangular housing 12 having a front opening 14. The housing 12 comprises a frame 16 having a front plate 18 and a rearwardly turned flange 20. A back cover 22 is fastened to the frame 16 by conventional fasteners (not shown).

A semi-transparent or vanishing mirror 24 is mounted to the frame 16 and is visible through the opening 14. Such a mirror works similar to a two-way mirror with suitable coatings materials, formula, and processes to achieve the clearest image when a display is activated and function as a reflective distortion free mirror when the display is off. The mirror 24 is formed of glass having a reflective coating that allows an image to transfer through the mirror when a light source is illuminated behind the mirror, and when the light source is off the device reflects like a conventional mirror. The present invention is not directed to any particular design of vanishing or semi-transparent mirror. Such designs are well known and do not form part of the invention.

A flat panel display monitor 26 is mounted in the housing 12 behind the mirror 14. The display monitor 26 includes a flat panel screen 28. The back cover 22 covers the back of the display monitor 26.

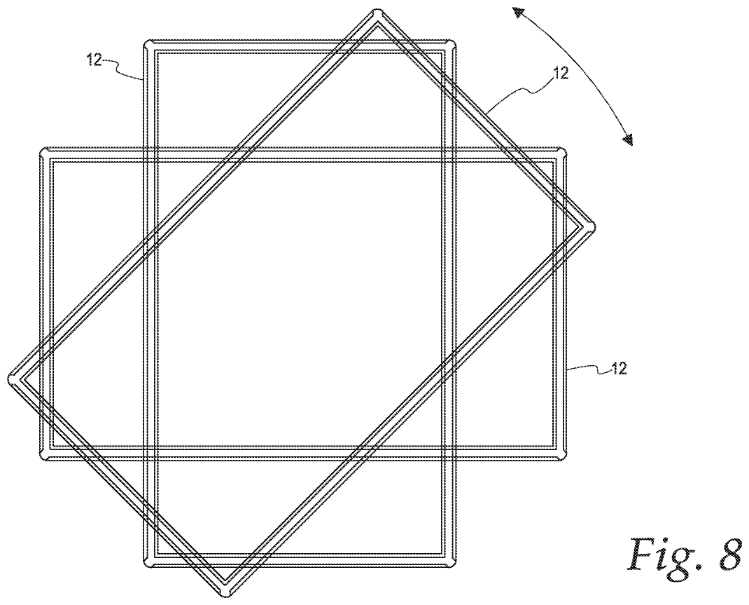

In the exemplary embodiment, the flat panel screen 28 is 43″ diagonal. Any size screen can be used, as desired. The flat panel screen 28 comprises a conventional HDTV display screen. The back cover 22 includes parallel brackets 30 for mounting to a stand or wall mount device (not shown). Advantageously, the wall mount device enables the housing 12 to be rotated between a landscape orientation, see FIG. 1, and a portrait orientation, see FIG. 2, as shown in FIG. 8.

The flat panel screen 28 is completely vanishing when off with premium glass technology for the mirror 24. The system 10 uses available technology to conceal the flat panel screen 28 and provide superior reflection while serving as a mirror.

The system 10 comprises a video control system 32 mounted to a rear panel 34 of the display monitor 26. Some of the video control system components and circuits are mounted to a main circuit board 36.

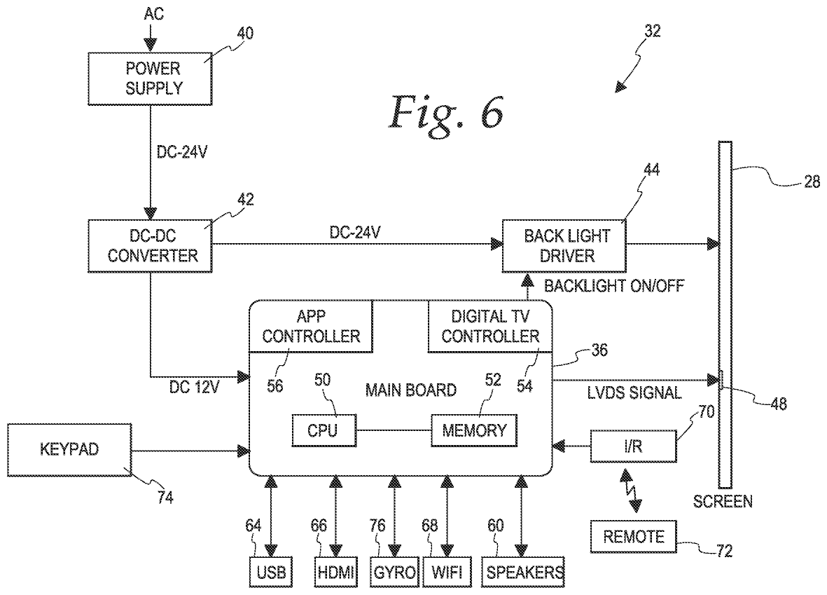

The video control system 32 is illustrated in block diagram form in FIG. 6. An AC power supply 40 converts AC power to 24V DC power supplied to a DC-DC converter circuit 42. The DC-DC converter circuit 42 supplies 24V DC power to a back light driver circuit 44 and 12V DC power to the main board 36. The main board 36 provides an LVDS display signal via a screen LVDS interface 48 to drive the display screen 28.

The main board 36 comprises a programmed CPU 50 and associated memory 52, a digital TV controller 54 and an app controller 56. As will be apparent, the digital TV controller 54 and the app controller 56 may be implemented in circuitry and/or software. The digital TV controller 54 may comprise a TV tuner and/or functionality to display streaming programs or the like. The app controller 56 is configured to implement available fitness apps or the like stored in the memory 52 and comprises a built in Android or iOS operating system so that the user can download any fitness app they would like, via an appropriate platform. The user can also stream from a mobile device, such as a phone or tablet, using an app that streams, or another streaming device.

The main board 36 drives a pair of speakers 60 and receives input signals from a connector panel 62. The connector panel 62 includes a USB connector 64 and an HDMI connector 66. A Wi-Fi antenna 68 receives radio frequency Wi-Fi signals. An infrared (IR) receiver 70 receives signals from a remote control 72 for controlling functionality. A keypad 74 also provides user input commands. An orientation sensor 76, such as a gyro, senses orientation of the housing 12, and thus the flat panel screen 28.

The back cover 22 includes an opening 80 providing user access to the main board 36 and the connector panel 62. The opening 80 is selectively partially closed by a cover 82 to protect the circuitry but provide access to the connector panel 62.

The main board 36 comprises the programmed processor or CPU 50 and the memory 52, and related circuitry (not shown), for driving the display screen 28. In accordance with the invention, the control system 32 when turned on implements one of an App function via the app controller 56 for fitness mode or TV operation via the DTV controller 54 for TV mode.

Typically, a flat panel screen is in a landscape orientation, see FIG. 1, for TV mode and portrait orientation for fitness mode. Portrait orientation is typically used in fitness mode to match the common fitness apps such as used on smart phones and tablet devices. Also, as the mirror is used by the user in fitness mode the vertical orientation is advantageous. In accordance with the invention, the control system 46 is configured to automatically switch between modes based on the panel orientation responsive to the gyro sensor 76. The system 10 seamlessly can be configured to transform from a mirror into a Home Gym and back to TV mode by rotating the housing 12. The user can choose how to work out. The system 10 allows immediate visual reflected feedback, enabling the user to match the form of a trainer. Alternatively, the mode can be controlled by the remote control 72 or the keypad 74 to override the automatic function.

The control system 46 is also configured to switch the display orientation automatically based on orientation of the housing 12 as sensed by the gyro sensor 76.

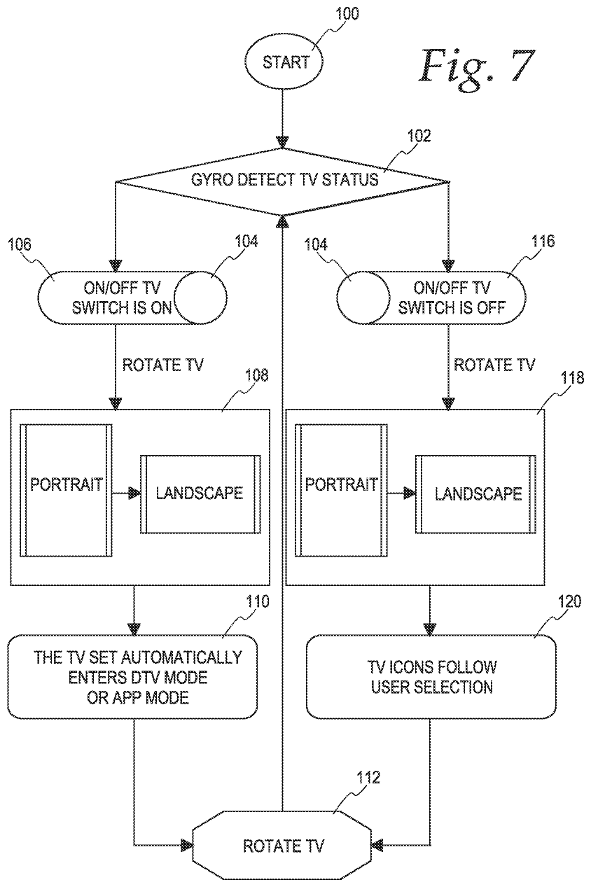

FIG. 7 illustrates an exemplary flow chart of control by the control system 32. The system 10 starts at power on 100. The gyro sensor 76 detects the panel orientation at a decision block 102.

The automatic operation to switch between TV mode and app mode uses a switch operation 104 to turn this function on and off. The switch 104 can be on the keypad 74 or be implemented via the remote control 72. The left side of the flow chart illustrates how the system 10 operates when the user turns the function on, and the right side illustrates how the system 10 operates when the user turns this function off.

If the function is on, as indicated at a node 106, then if the housing 12 is rotated from the portrait orientation to the landscape orientation, as indicate at the block 108, then the main board 36 generates the LVDS video signal from the DTV controller 54 as at the block 110. If the housing 12 is subsequently rotated, as determined at a decision block 112, then the control loops back to the block 102. Conversely, if the housing 12 is rotated from the landscape orientation to the portrait orientation, as indicate at the block 108, then the control system 46 generates the LVDS video signal from the app controller 56 as at the block 110.

If the function is off, as indicated at a node 116, then if the housing 12 is rotated from the portrait orientation to the landscape orientation, as indicate at the block 118, then the control system 46 generates the LVDS video signal from whichever one of the DTV controller 54 or the app controller 56 which the user selects at a block 120. If the housing 12 is subsequently rotated, as determined at a decision block 112, then the control loops back to the block 102. Thus, the switch operation 104 can override the automatic selection of mode based on orientation.

Thus, the invention described herein combines features of both a TV mirror and a fitness mirror in a single device and selectively automatically switches between modes based on orientation of the housing.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The foregoing disclosure of specific embodiments is intended to be illustrative of the broad concepts comprehended by the invention.

1. A combined fitness and television mirror comprising:
a generally rectangular housing having a front opening;
a semi-transparent mirror mounted in the housing front opening;
a display monitor mounted in the housing rearwardly of the mirror and visible through the mirror when the display monitor is in an on state; and
a video control system in the housing for generating video signals to drive the monitor, the video control system comprising a programmed processor and memory, a plurality of input ports, a television controller, an app controller and an orientation sensor for sensing orientation of the housing in one of a portrait mode or a landscape made, the video control system being configured to selectively generate the video signals from one of the television controller or the app controller and to adjust orientation of the video signals responsive to orientation of the housing.

2. The combined fitness and television mirror of claim 1 wherein said housing comprises a frame and a back cover.

3. The combined fitness and television mirror of claim 1 wherein the orientation sensor comprises a gyro sensor.

4. The combined fitness and television mirror of claim 1 wherein the control system comprises a Wi-Fi antenna for receiving input signals for the television controller and/or the app controller.

5. The combined fitness and television mirror of claim 1 wherein the control system comprises a HDMI input for receiving input signals for the television controller.

6. The combined fitness and television mirror of claim 1 wherein the control system comprises a USB input for receiving input signals for the app controller.

7. The combined fitness and television mirror of claim 1 wherein the display monitor has a screen size substantially equal to size of the front opening.

8. The combined fitness and television mirror of claim 1 further comprising a keypad operatively connected to the video control system and adapted to provide input commands to control selection of the video signals.

9. The combined fitness and television mirror of claim 1 further comprising an infrared receiver operatively connected to the video control system and adapted to receive input commands from a remote control to control selection of the video signals.

10. The combined fitness and television mirror of claim 1 wherein the television controller comprises a digital tuner.

11. A combined fitness and television mirror comprising:
a generally rectangular housing having a front opening;
a semi-transparent mirror mounted in the housing front opening;
a display monitor mounted in the housing rearwardly of the mirror and visible through the mirror when the display monitor is in an on state; and
a video control system in the housing for generating video signals to drive the monitor, the video control system comprising a programmed processor and memory, a plurality of input ports, a television controller to display television programs, an app controller to stream an exercise class, and an orientation sensor for sensing orientation of the housing in one of a portrait mode or a landscape made, the video control system being configured to generate the video signals from the television controller if the sensor senses the landscape orientation and to generate the video signals from the app controller if the sensor senses the portrait orientation.

12. The combined fitness and television mirror of claim 11 wherein said housing comprises a frame and a back cover.

13. The combined fitness and television mirror of claim 11 wherein the orientation sensor comprises a gyro sensor.

14. The combined fitness and television mirror of claim 11 wherein the control system comprises a WiFi antenna for receiving input signals for the television controller and/or the app controller.

15. The combined fitness and television mirror of claim 11 wherein the control system comprises a HDMI input for receiving input signals for the television controller.

16. The combined fitness and television mirror of claim 11 wherein the control system comprises a USB input for receiving input signals for the app controller.

17. The combined fitness and television mirror of claim 11 wherein the display monitor has a screen size substantially equal to size of the front opening.

18. The combined fitness and television mirror of claim 11 further comprising a keypad operatively connected to the video control system and adapted to provide input commands to override the orientation sensor to select the video signals.

19. The combined fitness and television mirror of claim 11 further comprising an infrared receiver operatively connected to the video control system and adapted to receive input commands from a remote control to override the orientation sensor to select the video signals.

20. The combined fitness and television mirror of claim 11 wherein the television controller comprises a digital tuner.
